(19) United States
(12) Patent Application Publication
(10) Pub. No.: US 2023/0318125 A1
(43) Pub. Date: Oct. 5, 2023

(54) MOTOR VEHICLE TRACTION BATTERY MODULE

(71) Applicant: Dr. Ing. h.c. F. Porsche Aktiengesellschaft, Stuttgart (DE)

(72) Inventors: Justus Speichermann, Stuttgart (DE); Christoph Orth, Marbach (DE)

(21) Appl. No.: 18/127,244

(22) Filed: Mar. 28, 2023

(30) Foreign Application Priority Data
Mar. 30, 2022 (DE) 10 2022 107 489.7

(51) Int. Cl. H01M 50/367; H01M 50/204; H01M 50/317; H01M 50/342

(52) U.S. Cl. CPC H01M 50/367; H01M 50/204; H01M 50/317; H01M 50/3425; H01M 2220/20; H01M 2200/20

(57) ABSTRACT

A motor vehicle traction battery module (10) has fluidically tight battery cells (201-206) arranged in a row. Each battery cell (201-206) has a degassing opening (32), and the cell degassing openings (22) of the battery cells (201-206) open into a single degassing passage (40) in a fluidically parallel manner. The degassing passage (40) leads to a single module degassing opening (49), so that a single degassing passage flow direction (S) is defined. Each downstream cell degassing opening (22) is associated with a degassing guide flap (30) that is hinged at the upstream flap edge (33) via a flap joint (32) and is biased in the closed position. Each degassing guide flap (30) closes the cell degassing opening (22) and opens the cell degassing opening (22) in the case of a cell degassing.

### CROSS-REFERENCE TO RELATED APPLICATION

This application claims priority on German Patent Application No 10 2022 107 489.7 filed Mar. 30, 2022, the entire disclosure of which is incorporated herein by reference.

### BACKGROUND

Field of the Invention. The invention relates to a motor vehicle traction battery module having fluidically tight battery cells arranged in a row, with each battery cell having a degassing opening.

Related Art Known battery cells typically have a degassing opening that is sealed fluidically with a rupture disc. Hot cell gases and particles escape through the degassing opening and into the interior of the traction battery module housing in a thermal failure event. DE 10 2013 201 365 A1 discloses a motor vehicle traction battery module, in which the degassing openings of the battery cells are arranged in a row and open into a single degassing passage in a fluidically parallel manner. Opposite ends of the degassing passage have module degassing openings at its two passage ends. Switching flaps are provided in the degassing passage between the cell degassing openings. All of the switching flaps fold in one of the two possible folding directions in the case of cell degassing, with the folding direction depending on the location of the degassing battery cell. Thus, two degassing directions are available for degassing in the degassing passage. Each fully folded switching flap thereby closes a cell degassing opening, so that the respective rupture disc is protected from the hot cell gas.

However, mechanical protection of the rupture discs of the intact battery cells is provided only when the switching flap is folded completely. The degassing concept with two module degassing openings is costly in terms of design.

An object of the invention is to create a simple motor vehicle traction battery module that provides improved protection of the intact battery cells in a degassing event.

### SUMMARY

A traction battery module in accordance with an embodiment of the invention comprises plural fluidically tight battery cells arranged in a row, with each of the battery cells having a degassing opening. The degassing openings of all of the battery cells lie in a common plane and are oriented in the same spatial direction, e.g. all of them may open vertically up. The degassing openings do not open in the direction of an immediately adjacent battery cell. The cell degassing openings of a series all open in a fluidically parallel manner into a single degassing passage leading to a single module degassing opening. Thus, a single degassing passage flow direction is established to simplify the construction of the traction battery module.

Most or all of the cell degassing openings are associated with a respective degassing guide flap that is biased into its closed position. The degassing flap that takes the closed or home position fluidically closes the respective cell degassing opening. Each degassing guide flap is hinged via a flap joint at the upstream flap edge so that the degassing guide flap is swung about the flap joint and into an open position by the gas pressure in the event of cell degassing. The upstream flap edge is the edge of the degassing flap or the edge of the degassing opening that fluidically farthest away from the module degassing opening of the degassing passage. At least during its opening movement, the degassing guide flap always diverts the cell gas flowing through the cell degassing opening in the direction of the degassing passage outlet, so that the exiting cell gas experiences a flow pulse in the direction of the degassing passage outlet.

All intact battery cells are forced into their closed position by the passage-side positive pressure. Thus, these degassing guide flaps remain reliably in their respective closed position. In this manner, the intact battery modules are protected reliably from the ingress of hot cell gases from another degassing battery cell.

In this way, a reliable protection of the intact battery cells is ensured in the event of degassing of a non-intact battery cell.

The degassing passage may have an opening stop that limits the opening movement of the degassing guide flap in a degassing event of a battery cell. A maximum opening angle in some embodiments is less than 90°. The opening stop prevents an opening movement of the degassing guide flap that is uncontrolled in terms of width. The degassing guide flap typically takes the stop position defined by the opening stop in a degassing event, and typically takes an orientation and slope so that the degassing guide flap redirects the outflowing gas into the degassing passage flow direction.

The degassing guide flap and the relevant region of the degassing passage of some embodiments are designed so that the degassing guide flap that is in its opening position closes fluidically and shields the upstream portion of the degassing passage from the downstream portion of the degassing passage that is fluidically connected to the opened cell degassing opening. This virtually completely prevents an influx of the hot cell gas into the upstream part of the degassing passage.

In such a design, any battery cell that is upstream of a battery cell that is experiencing a degassing event is protected from the cell gas of any downstream battery cells that is experiencing the degassing event. Thus, a degassing guide flap can be omitted from the most upstream battery cell. Thus, the cell degassing opening of the most upstream battery cell can be designed without a flap.

A flap joint can be any type of joint that enables the degassing guide flap to be unfolded once. This need not be a rotary joint in the narrower sense. For example, the flap joint of some embodiments is a bendable material bridge that is plastic or elastically deformable, i.e. bendable. The material bridge can form a film joint.

The degassing guide flaps of some embodiments are integral with a passage wall of the degassing passage. The degassing guide flaps can be manufactured, for example, by the degassing guide flap being punched out of the degassing passage wall body. The foldable flap joint is formed by a corresponding material weakening that can be generated by a notch. In this way, the degassing guide flaps are easy to manufacture.

Each cell degassing opening upstream of the degassing guide flap may be associated with a fluidically tight rupture disc. Thus, the degassing guide flap does not replace the fluidically tight rupture disc, but rather complements it. The degassing guide flap protects the rupture disc from the hot cell gas of another battery cell.

In some embodiments, the passage cross-section of the degassing passage increases from upstream to downstream by at least 30% between the upstream end and the downstream end. Widening the degassing passage reduces the pressure of the downstream cell gas and thereby reduces the gas temperature of the cell gas.

An exemplary embodiment of the invention will be explained in detail in the following paragraphs with reference to the drawings.

### BRIEF DESCRIPTION OF THE DRAWINGS

FIG. 1 is a schematic cross-sectional view of a traction battery module with fluidically tight battery cells arranged in a row, and with degassing openings open into a degassing passage, with most degassing openings comprising a degassing guide flap.

FIG. 2 is an enlarged cross-sectional view of a battery cell with the degassing guide flap of the motor vehicle traction battery module of FIG. 1.

FIG. 3 an enlarged cross-sectional view of the battery cell of FIG. 2, with a broken line depiction of the degassing guide flap in the open position.

### DETAILED ESCRIPTION

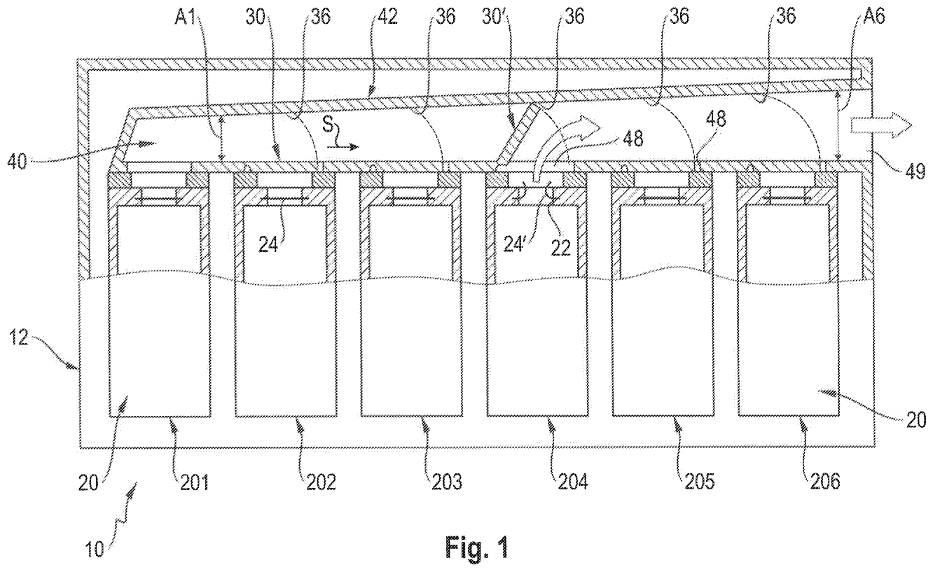

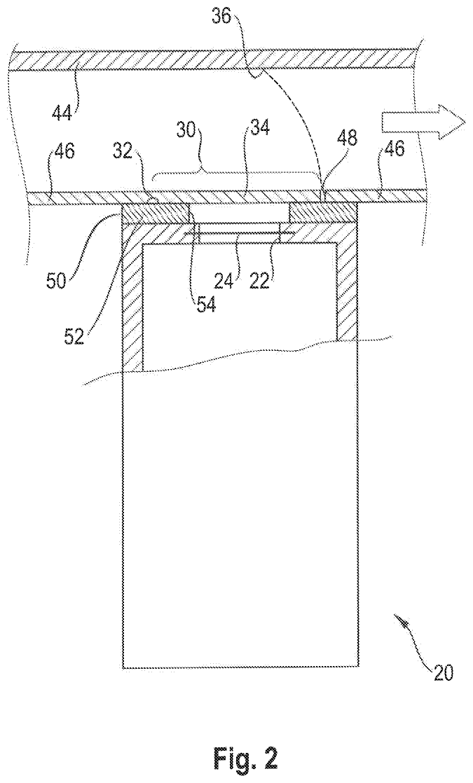

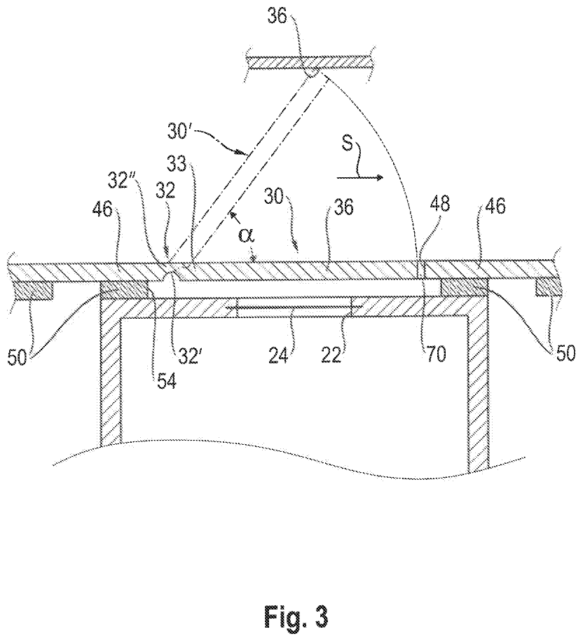

FIG. 1 schematically shows a motor vehicle traction battery module 10 in the longitudinal section XZ, and is typically plate-like in design and is installed with its plate plane lying in a horizontal plane XY in the vehicle floor. The traction battery module 10 is in a fluidically tight module housing 12 and has at least one row of fluidically tight, similar battery cells 201-206 that are interconnected electrically. In the present case, six similar battery cells 201-206 are shown by way of example, and one such battery cell 20 is shown in further detail in FIGS. 2 and 3.

Each battery cell 201-206 each has an overlying degassing opening 22 such that all of the degassing openings 22 lie in a single horizontal line x and in a single horizontal plane XY. A horizontal linear degassing passage 40 is above the degassing openings 22, and the cell degassing openings 22 of all of the battery cells 201-206 open in the degassing passage 40 a fluidically parallel manner.

The degassing passage 40 is bordered by an upper passage wall 42 and a lower passage wall 46. The lower passage wall 46 has respective passage wall openings 48 corresponding to the associated degassing openings 22 of the battery cells 201-206. A module degassing opening 49 is provided at the downstream end of the degassing passage 40, and cell gas can exit the degassing passage 40 outwardly through the module degassing opening 49. A single degassing passage flow direction S is thereby defined and extends in an upstream to downstream direction. The degassing passage 40 continuously and seamlessly widens from upstream to downstream by more than 50%, such that the passage cross-section A1 at the upstream end of the degassing passage 40 is approximately 50% smaller than the passage cross-section A6 at the downstream end of the degassing passage 40 at which the module degassing opening 49 is arranged.

A fluidically tight rupture disc 24 is arranged in each degassing opening 22 and seals the respective cell degassing opening 22 in a fluidically tight manner. The rupture discs 24 are designed to break up at a defined differential pressure such that, in a non-intact battery cell, the cell gas can escape from the cell interior through the degassing opening 22 into the degassing passage 40.

The sealing between the opening edge of a cell degassing opening 22 and the opening edge of the associated passage wall opening 48 is accomplished by an annular and electrically non-conductive seal 50 consisting of a seal body 52 made of Teflon or a suitable ceramic material and defining a seal opening 54, as shown in FIG. 2.

The five downstream cell degassing openings 22 are associated with a respective degassing guide flap 30 that is biased into its closed position and is connected to the upstream flap edge 33 via a flap joint 32. In contrast, the cell degassing opening 22 of the most upstream battery cell 201 is designed without a flap. The degassing guide flaps 30 are formed respectively by flap bodies 34 integral with the bottom metal passage wall 46. Each flap body 34 is formed by a U-shaped punching slot 70 that defines the corresponding passage wall opening 48 in the passage wall 46. The flap joint 32 is formed by a foldable material bridge 32″ made by a hinged notch 32′ introduced from the bottom.

An opening stop 36 is provided on the upper passage wall 42 by the wall body 44 for each degassing guide flap 30 and limits the opening movement of the relevant degassing guide flap 30′ to an opening angle a of approximately 60° in a degassing event of a battery cell 202-206, for example as indicated in FIG. 3. The opening stop 36 can be formed by the upper passage wall 42 itself, but can alternatively be formed by a corresponding stop bar. The degassing guide flap 30′ that is in its indicated open position in FIG. 3, forms a nearly fluidically tight seal between the upstream and downstream portions of the degassing passage 40 opposite the degassing guide flap 30′.

In FIGS. 2 and 3, an exemplary battery cell 20 including a degassing guide flap 30 corresponding to one of the five downstream battery cells 202-206 is shown in detail. During a thermal event in one of the latter five battery cells 202-206, the gas pressure of the cell gas of the relevant battery cell 20 first breaks down and destroys the rupture disc 24 from the inside, such that the cell gas exits upwardly through the burst rupture disc 24′, and the gas pressure of the cell gas pivots the degassing guide flap 30 into its opening position. The opened and stopped degassing guide flap 30′ guides the hot cell gas into the degassing passage flow direction S in the direction of the module degassing opening 49. Due to the downstream widening of the degassing passage 40, the gas pressure of the flowing cell gas decreases accordingly so that the cell gas cools down in a basically adiabatic manner.

The gas pressure of the cell gas in the relevant section of the degassing passage 40 forces the degassing guide flaps 30 downstream of the opened degassing guide flap 30′ into their respective closed position, so that the relevant rupture discs 24 are protected from the positive pressure as well as the hot cell gas.

1. A motor vehicle traction battery module (10) comprising: a plurality of fluidically tight battery cells (201-206) arranged in a row, each of the battery cells (201-206) having a degassing opening (22) and the cell degassing openings (22) of the battery cells (201-206) open into a single degassing passage (40) in a fluidically parallel manner, wherein:
the degassing passage (40) leads to a single module degassing opening (49) so that a single degassing passage flow direction (S) is defined, and
each of the cell degassing openings (22) that is downstream of at least one other one of the cell degassing openings (22) is associated with a degassing guide flap (30) that is biased into a closed position, each of the degassing guide flap (30) is hinged via a flap joint (32) at an upstream flap edge (33) with respect to the single degassing passage flow direction (S), the degassing guide flap (30) closes the cell degassing opening (22) and releases the relevant cell degassing opening (22) in the case of a cell degassing.

2. The motor vehicle traction battery module (10) of claim 1, further comprising opening stops (36) in the degassing passage (40), the opening stops (36) being disposed to limit an opening movement of the degassing guide flap (30) to a maximum opening angle (a) of less than 90° in a degassing event of a battery cell (202-206).

3. The motor vehicle traction battery module (10) of claim 2, wherein each of the degassing guide flaps (30) is configured to fluidically close an upstream portion of the degassing passage (40) when the respective degassing guide flap (30) is stopped open position.

4. The motor vehicle traction battery module (10) of claim 1, wherein the flap joint (32) is a bendable material bridge (32″).

5. The motor vehicle traction battery module (10) of claim 1, wherein each of the degassing guide flaps (30) is integral with a passage wall (46) of the degassing passage (40).

6. The motor vehicle traction battery module (10) of claim 1, wherein each of the cell degassing openings (22) is associated with a fluidically tight rupture disc (24).

7. The motor vehicle traction battery module (10) of claim 1, wherein the degassing passage (40) has a passage cross-section (A1, A6) that increases from upstream to downstream, preferably by at least 30%.

8. The motor vehicle traction battery module (10) of claim 7, wherein the passage cross-section (A1, A6) of the degassing passage (40) increases from upstream to downstream by at least 30%.

9. The motor vehicle traction battery module (10) of claim 1, wherein the cell degassing opening (22) that is most upstream in the degassing passage (40) has no guide flaps (30).
